(19) United States
(12) Patent Application Publication
(10) Pub. No.: US 2013/0009454 A1
(43) Pub. Date: Jan. 10, 2013

(54) REGENERATIVE BRAKING SYSTEM FOR VEHICLE

(75) Inventor: Gab Bae Jeon, Gunpo-si (KR)

(73) Assignee: HYUNDAI MOTOR COMPANY, Seoul (KR)

(21) Appl. No.: 13/313,960

(22) Filed: Dec. 7, 2011

(30) Foreign Application Priority Data
Jul. 8, 2011 (KR) 10-2011-0068107

(51) Int. Cl. B60T 13/58; B60T 13/74

(52) U.S. Cl. 303/3

(57) ABSTRACT

A regenerative braking system for a vehicle improves accuracy of a control. The regenerative braking system for a vehicle is operated by hydraulic pressure. The regenerative braking system may include a first cylinder adapted to directly generate hydraulic pressure by a driver's maneuver; a second cylinder adapted to generate hydraulic pressure necessary for braking of the vehicle and to deliver the hydraulic pressure to a wheel; a hydraulic pressure generator adapted to recognize braking force demanded by the driver and to generate hydraulic pressure; and a first valve interposed between the first cylinder and the second cylinder and adapted to selectively supply the hydraulic pressure generated by the first cylinder to the second cylinder.

### CROSS-REFERENCE TO RELATED APPLICATION

This application claims priority to and the benefit of Korean Patent Application No. 10-2011-0068107 filed Jul. 8, 2011, the entire contents of which application is incorporated herein for all purposes by this reference.

### BACKGROUND OF INVENTION

1. Field of Invention

The present invention relates to a regenerative braking system for a vehicle. More particularly, the present invention relates to a regenerative braking system for a vehicle that improves accuracy of a control.

2. Description of Related Art

Generally, braking of a vehicle is performed by converting kinetic energy of the running vehicle into other types of energy.

One of the braking of the vehicle is regenerative braking. According to the regenerative braking, a generator is driven or a motor is operated as a generator by the kinetic energy of the vehicle so as to generate electric energy, and a battery is charged by the electric energy. That is, the braking is performed by converting the kinetic energy of the vehicle into the electrical energy. Such regenerative braking is mainly used in an electric vehicle.

Meanwhile, braking force demanded by a driver is sum of braking force of hydraulic pressure catching a wheel and regenerative braking force charging the battery in the regenerative braking. That is, a regenerative braking system generates the braking force of hydraulic pressure and the regenerative braking force respectively based on the braking force demanded by the driver. Herein, a hydraulic pressure corresponding to the braking force of hydraulic pressure is generated by a master cylinder. However, a target hydraulic pressure corresponding to the braking force of hydraulic pressure is not the same as an actual hydraulic pressure of the master cylinder. If a difference between the target hydraulic pressure and the actual hydraulic pressure is large, accuracy of a braking control may be deteriorated.

For example, pistons used in a conventional master cylinder are provided with a seal. Herein, resistance of the seal is applied to a direction opposite to a moving direction of the piston, that is a direction to which the braking force of hydraulic pressure is applied. Therefore, as the resistance of the seal becomes large, the difference between the target hydraulic pressure and the actual hydraulic pressure becomes also large. That is, if a plurality of pistons is used in the master cylinder, it is difficult to reduce the number of seals or the resistance of the seals.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a regenerative braking system for a vehicle having advantages of improving accuracy of a braking control.

The present invention has been made in an effort to provide a regenerative braking system for a vehicle having further advantages of reducing product cost and improving operating efficiency by simplifying structures thereof.

A regenerative braking system for a vehicle according to various aspects of the present invention is operated by hydraulic pressure and may include a first cylinder adapted to directly generate hydraulic pressure by a driver's maneuver; a second cylinder adapted to generate hydraulic pressure necessary for braking of the vehicle and to deliver the hydraulic pressure to a wheel; a hydraulic pressure generator adapted to recognize braking force demanded by the driver and to generate hydraulic pressure; and a first valve interposed between the first cylinder and the second cylinder and adapted to selectively supply the hydraulic pressure generated by the first cylinder to the second cylinder.

The second cylinder may be adapted to generate the hydraulic pressure necessary for the braking of the vehicle by receiving the hydraulic pressure from the hydraulic pressure generator or receiving the hydraulic pressure from the first cylinder.

The first cylinder may have a first piston and the second cylinder may have a second piston, wherein the second cylinder may further have an elastic member.

One end of the first piston may contact with a push rod moved by the driver's maneuver.

The push rod may push the one end of the first piston by the driver's maneuver and the first piston moves to a length direction thereof and applies pressure to fluid so as to generate the hydraulic pressure.

The second cylinder may be divided into a first pressure chamber and a second pressure chamber by the second piston provided with a seal.

The elastic member may be disposed in the second pressure chamber and may be adapted to elastically support the second piston.

The first pressure chamber and the second pressure chamber may be respectively provided with hydraulic pressure lines connected to different wheels.

The first cylinder may be connected to the first pressure chamber through a first hydraulic pressure line, and a first valve may be provided at the first hydraulic pressure line.

The first hydraulic pressure line may be divaricated between the first valve and the first cylinder and may be connected to a reaction force generator, wherein a second valve may be provided at the divaricated hydraulic pressure line.

The reaction force generator may be adapted to generate reaction force against force by which the push rod pushes the first piston when the first valve is closed and the second valve is open.

The hydraulic pressure may be delivered to the first pressure chamber when the first valve is open.

The first pressure chamber may be connected to the hydraulic pressure generator through a second hydraulic pressure line.

The hydraulic pressure generator may be adapted to deliver the hydraulic pressure to the first pressure chamber or to receive the hydraulic pressure from the first pressure chamber.

The hydraulic pressure generator may be connected to a reservoir tank through a third hydraulic pressure line.

One end of a fourth hydraulic pressure line may be connected to the reservoir tank, and the other end thereof may be divaricated and connected to the first and second cylinders.

The second pressure chamber may be connected to the hydraulic pressure generator through a fifth hydraulic pressure line such that the first pressure chamber and the second pressure chamber are controlled independently.

The hydraulic pressure generator may be adapted to deliver the hydraulic pressure to the second pressure chamber or to receive the hydraulic pressure from the second pressure chamber.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary regenerative braking system for a vehicle according to the present invention.

FIG. 2 is a schematic diagram of another exemplary regenerative braking system for a vehicle according to the present invention.

FIG. 3 is a detailed view of a hydraulic pressure generator shown in FIG. 1.

FIG. 4 is a detailed view of a hydraulic pressure generator shown in FIG. 2.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

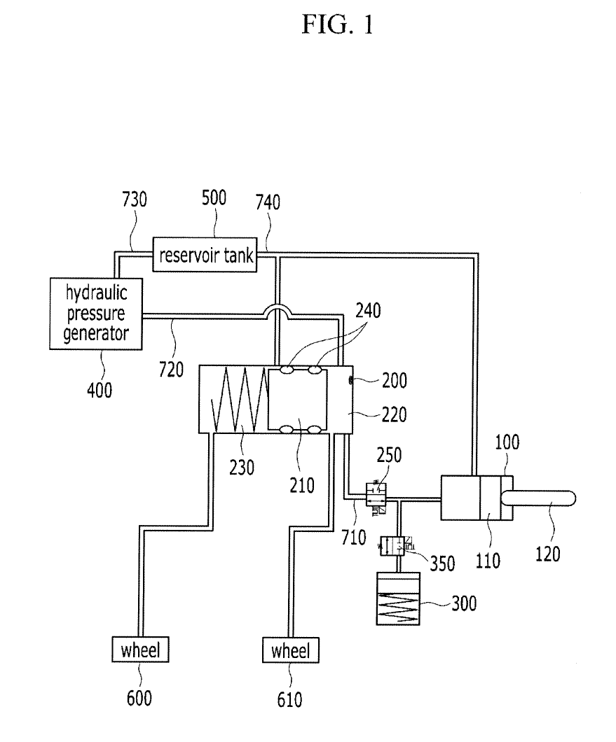

In a regenerative braking system for a vehicle according to various embodiments of the present invention, the number of pistons provided in a master cylinder is reduced, and two cylinders are disposed in parallel. Hereinafter, a regenerative braking system for a vehicle according to various embodiments of the present invention will be described in detail with reference to FIGS. 1 to 4.

FIG. 1 is a schematic diagram of a regenerative braking system for a vehicle according to various embodiments of the present invention.

As shown in FIG. 1, a regenerative braking system for a vehicle according to various embodiments of the present invention includes a first cylinder 100, a second cylinder 200, a reaction force generator 300, a hydraulic pressure generator 400, a reservoir tank 500, and a plurality of hydraulic pressure lines.

The first cylinder 100 generates hydraulic pressure by driver's maneuver. In addition, the first cylinder 100 is provide with a first piston 110 and a push rod 120.

The first piston 110 is provided in the first cylinder 100. One end of the push rod 120 is connected to a pedal maneuverable by a driver and the other end of the push rod 120 contacts with the first piston 110. Therefore, if the driver manipulates the pedal, the push rod 120 is moved and pushes the first piston 110. The piston applies pressure to fluid filled in the first cylinder 100 and generates the hydraulic pressure.

In this specification, it is exemplified that the push rod 120 is moved by the pedal manipulated by the driver. However, movement of the push rod 120 can be achieved by other means.

The second cylinder 200 receives hydraulic pressure from the hydraulic pressure generator 400 and generates hydraulic pressure necessary for braking. In various embodiments, an accumulator is disposed between the hydraulic pressure generator 400 and the second cylinder 200.

Herein, the second cylinder 200 is a master cylinder generating the hydraulic pressure corresponding to braking force demanded by the driver. In addition, the accumulator accumulates and supplies the hydraulic pressure when needed.

For example, if the driver presses down the pedal, a pedal stroke sensor detects a displacement of the pedal and delivers an electrical signal corresponding to the displacement to the hydraulic pressure generator 400. In addition, the hydraulic pressure generator 400 receiving the signal delivers the hydraulic pressure corresponding to the braking force of hydraulic pressure demanded by the driver to the second cylinder 200 through the accumulator. Herein, the braking force of hydraulic pressure demanded by the driver, as described above, is braking force calculated by subtracting regenerative braking force from braking force demanded by the driver.

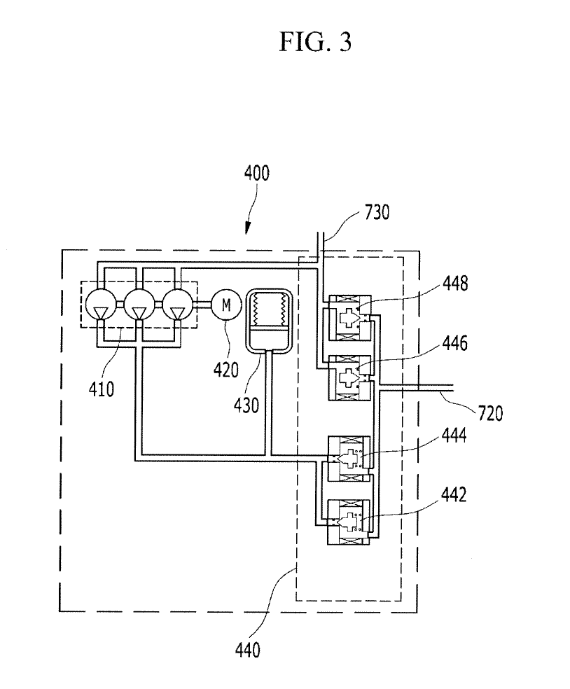

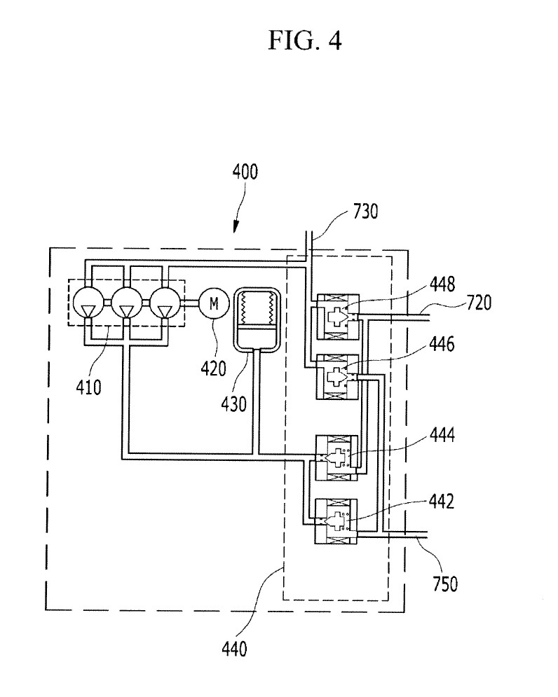

The accumulator applied to a hydraulic pressure braking system is well known to a person skilled in the art, and thus detailed description thereof will be omitted. In this specification, the accumulator may be a high-pressure tank 430 (referring to FIG. 3 and FIG. 4).

A second piston 210 is provided in the second cylinder 200. In addition, the second cylinder 200 is divided into a first pressure chamber 220 and a second pressure chamber 230 by the second piston 210.

A seal 240 is provided at an exterior circumference of the second piston 210 and blocks fluid flow between the first pressure chamber 220 and the second pressure chamber 230.

The first pressure chamber 220 receives the hydraulic pressure from the accumulator. In addition, the hydraulic pressure necessary for the braking is generated by the first pressure chamber 220 and is delivered to a wheel 610. Further, the second piston 210 is pushed by the hydraulic pressure generated at the first pressure chamber 220 and applies pressure to fluid filled in the second pressure chamber 230. Therefore, hydraulic pressure is generated at the second pressure chamber 230.

The second pressure chamber 230 delivers the hydraulic pressure to a wheel 600. In addition, an elastic member for elastically supporting the second piston 210 is provided in the second pressure chamber 230. The elastic member moves the second piston 210 to an original position when the hydraulic pressure of the first pressure chamber 220 decreases.

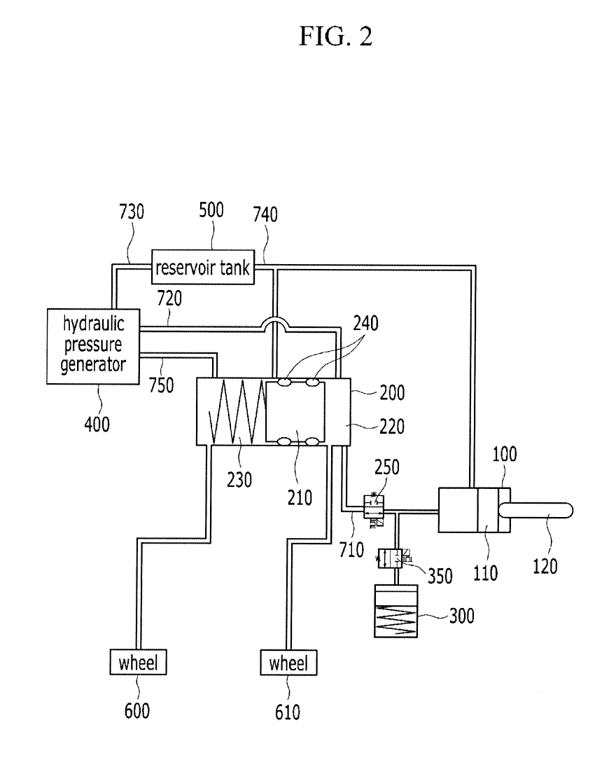

It is exemplified in FIG. 1 and FIG. 2 that a spring is used as the elastic member, but the elastic member is not limited to the spring. Any means for supplying restoring force to the second piston 210 can be used as the elastic member.

The hydraulic pressures supplied to the wheels 600 and 610 operate a wheel cylinder and perform the braking of the vehicle. Herein, the wheel 600 connected to the second pressure chamber is different from that 610 connected to the first pressure chamber. For example, the wheels 600 are a front left wheel and a rear right wheel, and the wheels 610 are a front right wheel and a rear left wheel in various embodiments. In various embodiments, the wheels 600 are front left and right wheels, and the wheels 610 are rear left and right wheels.

The hydraulic pressure generator 400 controls hydraulic pressure and flow of fluid in the regenerative braking system for a vehicle. In addition, the hydraulic pressure generator 400 calculates a target braking force of the vehicle and calculates a regenerative braking force and a braking force of hydraulic pressure according to the target braking force. Therefore, the hydraulic pressure generator 400 controls the hydraulic pressure and the flow of the fluid.

The reservoir tank 500 prepares a volumetric change of the fluid according to pressure and temperature thereof That is, the reservoir tank 500 supplies the fluid when the regenerative braking system lacks the fluid and stores the fluid when excessive fluid is in the regenerative braking system.

The hydraulic pressure lines includes a first hydraulic pressure line 710, a second hydraulic pressure line 720, a third hydraulic pressure line 730, and a fourth hydraulic pressure line 740, and further includes hydraulic pressure lines connecting the wheels 600 and 610 with the pressure chambers 220 and 230.

The first hydraulic pressure line 710 connects the first cylinder 100 with the first pressure chamber 220 of the second cylinder 200. In addition, a first valve 250 is provided at the first hydraulic pressure line 710. The first valve 250 is open or closed selectively so as to deliver the hydraulic pressure to the first pressure chamber 220 or not.

Meanwhile, the first hydraulic pressure line 710 is divaricated between the first cylinder 100 and the first valve 250 and is connected to the reaction force generator 300. In addition, a second valve 350 is provided at the divaricated the first hydraulic pressure line 710 so as to open or close it. Further, a piston and an elastic member are provided at the reaction force generator 300 such that reaction force against the hydraulic pressure delivered to the reaction force generator 300 can be generated.

If the push rod 120 moves, the first piston 110 applies pressure to the fluid in the first cylinder 100 and the hydraulic pressure is generated. At this time, if the first valve 250 is closed and the second valve 350 is open, the hydraulic pressure is delivered to the reaction force generator 300 and the reaction force against the hydraulic pressure is generated. Resultantly, the reaction force is a reaction force to manipulation of a pedal done by the driver.

A method for generating the reaction force by the reaction force generator 300 is not limited to the method described in this specification, and can be achieved variously by a person skilled in the art.

If the hydraulic pressure is hard to be generated in the first pressure chamber 220 by the hydraulic pressure delivered from the accumulator, the hydraulic pressure generated at the first cylinder 100 is delivered to the first pressure chamber 220. Such an operation is performed by opening the first valve 250. That is, if the regenerative braking system operates normally, the first valve 250 is always closed. If the regenerative braking system does not operate normally, the first valve 250 is open.

The second hydraulic pressure line 720 connects the first pressure chamber 220 with the hydraulic pressure generator 400.

If the hydraulic pressure of the first pressure chamber 220 is lowered, the hydraulic pressure of the first pressure chamber 220 is delivered to the hydraulic pressure generator 400 and lowering pressure is performed. If the hydraulic pressure of the first pressure chamber 220 is increased, the first pressure chamber 220 receives the hydraulic pressure from the hydraulic pressure generator 400 and increasing pressure is performed.

The third hydraulic pressure line 730 connects the hydraulic pressure generator 400 with the reservoir tank 500. The fluid flowing into the hydraulic pressure generator 400 through the second hydraulic pressure line 720 is discharged through the third hydraulic pressure line 730 and is then stored in the reservoir tank 500. The reservoir tank 500 supplies the fluid to the regenerative braking system depending on the circumstances.

The fourth hydraulic pressure line 740 connects the reservoir tank 500 with the first cylinder 100. In addition, the fourth hydraulic pressure line 740 is divaricated between the reservoir tank 500 and the first cylinder 100, and is connected to the second pressure chamber 230 of the second cylinder 200. That is, the fluid stored in the reservoir tank 500 is supplied to the first cylinder 100 and the second pressure chamber 230.

The hydraulic pressure lines connecting the wheels 600 and 610 with the pressure chambers 220 and 230, as described above, connects the first pressure chamber 220 and the second pressure chamber 230 with the different wheels 600 and 610.

FIG. 2 is a schematic diagram of a regenerative braking system for a vehicle according to various embodiments of the present invention.

For convenience of description, the same constituent elements are represented by the same reference numerals, and detailed description thereto will be omitted.

As shown in FIG. 2, a regenerative braking system for a vehicle according to various embodiments of the present invention further includes a fifth hydraulic pressure line 750.

The fifth hydraulic pressure line 750 connects the second pressure chamber 230 of the second cylinder 200 with the hydraulic pressure generator 400. Therefore, the hydraulic pressures of the first pressure chamber 220 and the second pressure chamber 230 can be independently controlled by the hydraulic pressure generator 400.

FIG. 3 is a detailed view of a hydraulic pressure generator shown in FIG. 1.

As shown in FIG. 3, the hydraulic pressure generator 400 according to various embodiments of the present invention includes a pump 410, a motor 420, a high-pressure tank 430, and a pressure regulator 440.

At least one of the pumps 410 and the motors 420 can be provided in the hydraulic pressure generator 400.

The pump 410 pumps the fluid by the motor 420 and flows the fluid in the regenerative braking system.

The high-pressure tank 430 is provided in the hydraulic pressure generator 400 so as to maintain the hydraulic pressure in the hydraulic pressure generator 400 to be higher than a predetermined pressure. That is, the fluid can be stored in the high-pressure tank 430, and a space in which the fluid is stored is connected to hydraulic pressure lines exterior of the high-pressure tank 430. In addition, the fluid stored in the high-pressure tank 430 is pressurized so as to maintain the hydraulic pressure in the high-pressure tank 430 to be higher than the predetermined pressure. Therefore, the fluid can flows out from the hydraulic pressure generator 400 smoothly.

The pressure regulator 440 controls a plurality of pressure control valves and the hydraulic pressure of the regenerative braking system.

In FIG. 3 and FIG. 4, four pressure control valves 442, 444, 446, and 448 are shown, but the number of pressure control valves is not limited to this.

The second hydraulic pressure line 720 connected to the hydraulic pressure generator 400 has four branches in the pressure regulator 440, and the four branches are connected respectively to four pressure control valves 442, 444, 446, and 448. In addition, the four pressure control valves 442, 444, 446, and 448 are open or closed selectively so as to control the hydraulic pressure of the second cylinder 200 and the regenerative braking system.

If the first and second pressure control valves 442 and 444 are open, the fluid in the hydraulic pressure generator 400 discharges from the hydraulic pressure generator 400 through the second hydraulic pressure line 720. In addition, the discharged fluid flows into the first pressure chamber 220 through the second hydraulic pressure line 720. Therefore, the hydraulic pressure of the first pressure chamber 220 increases and the hydraulic pressure of the second pressure chamber 230 also increases by operation of the second piston 210. Therefore, the hydraulic pressure of the second pressure chamber 230 becomes the same as that of the first pressure chamber 220.

One or both of the first and second pressure control valves 442 and 444 can be open depending on the circumstances.

If the third and fourth pressure control valves 446 and 448 are open, the fluid from the outside of the hydraulic pressure generator 400 flows in the hydraulic pressure generator 400 through the second hydraulic pressure line 720. In addition, the inflow fluid passes through the third and fourth pressure control valves 446 and 448. A portion of the inflow fluid flows in the pump 410 and the other portion of the inflow fluid flows out from the hydraulic pressure generator 400 through the third hydraulic pressure line 730. Therefore, the hydraulic pressure of the first pressure chamber 220 connected to the hydraulic pressure generator 400 through the second hydraulic pressure line 720 is lowered, and the hydraulic pressure of the second pressure chamber 230 is also lowered by operation of the second piston 210. Therefore, the hydraulic pressure of the second pressure chamber 230 becomes the same as that of the first pressure chamber 220.

One or both the third and fourth pressure control valves 446 and 448 can be open depending on the circumstances.

FIG. 4 is a detailed view of a hydraulic pressure generator shown in FIG. 2.

As shown in FIG. 4, the hydraulic pressure generator 400 according to various embodiments of the present invention further includes a fifth hydraulic pressure line 750. In addition, the hydraulic pressure of the first pressure chamber 220 and the second pressure chamber 230 can be independently controlled by the fifth hydraulic pressure line 750. Therefore, the hydraulic pressure can be controlled with more accuracy.

The second hydraulic pressure line 720 connected to the hydraulic pressure generator 400 is divaricated into two branches in the pressure regulator 440. One branch is connected to one of the first and second pressure control valves 442 and 444 and the other branch is connected to one of the third and fourth pressure control valves 446 and 448. In addition, the fifth hydraulic pressure line 750 connected to the hydraulic pressure generator 400 is divaricated into two branches in the pressure regulator 440. The two branches are connected to two control valves among four pressure control valves 442, 444, 446, and 448 that are not connected to the second hydraulic pressure line 720.

The four pressure control valves 442, 444, 446, and 448 are open or closed selectively so as to control the hydraulic pressure of the second cylinder 200 and the regenerative braking system.

If the first and second pressure control valves 442 and 444 are open, the fluid in the hydraulic pressure generator 400 discharges from the hydraulic pressure generator 400 through the second hydraulic pressure line 720 and the fifth hydraulic pressure line 750. In addition, the discharged fluid through the second hydraulic pressure line 720 flows into the first pressure chamber 220, and the discharged fluid through the fifth hydraulic pressure line 750 flows into the second pressure chamber 230. Therefore, the hydraulic pressure of the first pressure chamber 220 and the second pressure chamber 230 increases, and the hydraulic pressure of the second pressure chamber 230 becomes the same as that of the first pressure chamber 220 by operation of the second piston 210.

If the third and fourth pressure control valves 446 and 448 are open, the fluid from the outside of the hydraulic pressure generator 400 flows into the hydraulic pressure generator 400 through the second hydraulic pressure line 720 and the fifth hydraulic pressure line 750. In addition, the inflow fluid passes through the third and fourth pressure control valves 446 and 448. A portion of the inflow fluid flows in the pump 410 and the other portion of the inflow fluid flows out from the hydraulic pressure generator 400 through the third hydraulic pressure line 730. Therefore, the hydraulic pressure of the first pressure chamber 220 connected to the hydraulic pressure generator 400 through the second hydraulic pressure line 720 is lowered, and the hydraulic pressure of the second pressure chamber 230 connected to the hydraulic pressure generator 400 through the fifth hydraulic pressure line 750 is also lowered. Therefore, the hydraulic pressure of the second pressure chamber 230 becomes the same as that of the first pressure chamber 220 by operation of the second piston 210.

The first, second, third, and fourth pressure control valves 442 and 444 can be open or closed independently depending on the circumstances.

As described above, a difference between braking force of hydraulic pressure demanded by a driver and actual hydraulic pressure generated at a master cylinder may be reduced according to various embodiments of the present invention. Therefore, accuracy of braking control may be improved.

In addition, structures of the regenerative braking system for a vehicle may be simplified. Therefore, production cost may be curtailed.

Since a cylinder provided with a push rod is connected to the master cylinder through hydraulic pressure lines, various layouts can be achieved and spatial utility may be improved.

For convenience in explanation and accurate definition in the appended claims, the terms rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A regenerative braking system for a vehicle that is operated by hydraulic pressure, comprising:
a first cylinder adapted to directly generate hydraulic pressure by a driver's maneuver;
a second cylinder adapted to generate hydraulic pressure necessary for braking of the vehicle and to deliver the hydraulic pressure to a wheel;
a hydraulic pressure generator adapted to recognize a desired braking force demanded by the driver and to generate hydraulic pressure; and
a first valve interposed between the first cylinder and the second cylinder and adapted to selectively supply the hydraulic pressure generated by the first cylinder to the second cylinder.

2. The regenerative braking system of claim 1, wherein the second cylinder is adapted to generate the hydraulic pressure necessary for the braking of the vehicle by receiving the hydraulic pressure from the hydraulic pressure generator or receiving the hydraulic pressure from the first cylinder.

3. The regenerative braking system of claim 1, wherein the first cylinder has a first piston and the second cylinder has a second piston, and wherein the second cylinder further has an elastic member.

4. The regenerative braking system of claim 3, wherein one end of the first piston contacts with a push rod moved by the driver's maneuver.

5. The regenerative braking system of claim 4, wherein the push rod pushes the one end of the first piston by the driver's maneuver and the first piston moves in a length direction thereof and applies pressure to fluid so as to generate the hydraulic pressure.

6. The regenerative braking system of claim 3, wherein the second cylinder is divided into a first pressure chamber and a second pressure chamber by the second piston provided with a seal.

7. The regenerative braking system of claim 6, wherein the elastic member is disposed in the second pressure chamber and is adapted to elastically support the second piston.

8. The regenerative braking system of claim 6, wherein the first pressure chamber and the second pressure chamber are respectively provided with hydraulic pressure lines connected to different wheels.

9. The regenerative braking system of claim 6, wherein the first cylinder is connected to the first pressure chamber through a first hydraulic pressure line, and a first valve is provided at the first hydraulic pressure line.

10. The regenerative braking system of claim 9, wherein the first hydraulic pressure line is divaricated between the first valve and the first cylinder and is connected to a reaction force generator, wherein a second valve is provided at the divaricated hydraulic pressure line.

11. The regenerative braking system of claim 10, wherein the reaction force generator is adapted to generate reaction force against force by which the push rod pushes the first piston when the first valve is closed and the second valve is open.

12. The regenerative braking system of claim 10, wherein the hydraulic pressure is delivered to the first pressure chamber when the first valve is open.

13. The regenerative braking system of claim 12, wherein the first pressure chamber is connected to the hydraulic pressure generator through a second hydraulic pressure line.

14. The regenerative braking system of claim 13, wherein the hydraulic pressure generator is adapted to deliver the hydraulic pressure to the first pressure chamber or to receive the hydraulic pressure from the first pressure chamber.

15. The regenerative braking system of claim 13, wherein the hydraulic pressure generator is connected to a reservoir tank through a third hydraulic pressure line.

16. The regenerative braking system of claim 13, wherein one end of a fourth hydraulic pressure line is connected to the reservoir tank, and the other end thereof is divaricated and connected to the first and second cylinders.

17. The regenerative braking system of claim 13, wherein the second pressure chamber is connected to the hydraulic pressure generator through a fifth hydraulic pressure line such that the first pressure chamber and the second pressure chamber are controlled independently.

18. The regenerative braking system of claim 17, wherein the hydraulic pressure generator is adapted to deliver the hydraulic pressure to the second pressure chamber or to receive the hydraulic pressure from the second pressure chamber.
